(19) United States
(12) Patent Application Publication
(10) Pub. No.: US 2004/0125153 A1
(43) Pub. Date: Jul. 1, 2004

(54) Multiple input foci

(75) Inventor: Joseph Peter Robert Tosey, North Vancouver (CA)

Correspondence Address: Robert E. Krebs, THELEN REID & PRIEST LLP, P.O. Box 640640, San Jose, CA, 95164-0640, US

(73) Assignee: Sierra Wireless, Inc. a Canadian corp.

(21) Appl. No.: 10/335,250

(22) Filed: Dec. 31, 2002

(51) Int. Cl. G09G 5/00

(52) U.S. Cl. 345/863

(57) ABSTRACT

The present invention provides multiple foci so that a user may enter input into multiple objects without having to switch between them. This may be accomplished by mapping certain types of input events to specific objects within the graphical user interface. Thus, when inputs of a certain type are received, one focus is utilized, wherein when inputs of another type are received, a different focus may be utilized.

### FIELD OF THE INVENTION

The present invention relates to the field of graphical user interfaces. More particularly, the present invention relates to incorporating multiple input foci into a graphical user interface.

### BACKGROUND OF THE INVENTION

In a graphical user interface (GUI), such as the Microsoft™ Windows Interface, a focus may be described as the ability to receive user input through an input device, such as a mouse or keyboard. When an object in the GUI has the focus, it can receive input from a user. In multitasking environments, such as the Windows interface, several applications can be running at any time, but only the application with the focus has an active title bar and can receive input. On a Visual Basic form with several text boxes, only the text box with the focus will display text entered by means of the keyboard. When some objects have the focus, they appear with a highlighted border around the caption. FIG. 1 is a diagram illustrating a command button showing focus. As can be seen, the “OK” button 100 has the focus. In order for the user to interact with another object, he must shift the focus to the other object (in FIG. 1., this would be accomplished by moving a mouse cursor to the “cancel” button 102 and clicking on it).

However, there are situations where having only a single focus can hurt the efficiency of data entry and/or navigation. For example, users may typically search through a portal using one of two methods: a search method (such as entering a keyword string and finding matches) and a drill-down method (such as drilling through a hierarchy of menus). These two methods are completely separate concepts, and a user is clearly in one mode or the other. However, if the user often needs to switch back and forth between objects on the screen (such as between the two search methods), the extra step of “shifting focus” each time can be quite time consuming. Furthermore, on certain types of devices, such as Personal Data Assistants (PDAs) or cellular phones, navigation can be quite difficult and anything that can be done to reduce a required number of navigation events will be greatly beneficial.

What is needed is a solution that allows a user to perform input on multiple objects simultaneously.

### BRIEF DESCRIPTION OF THE INVENTION

The present invention provides multiple foci so that a user may enter input into multiple objects without having to switch between them. This may be accomplished by mapping certain types of input events to specific objects within the graphical user interface. Thus, when inputs of a certain type are received, one focus is utilized, wherein when inputs of another type are received, a different focus may be utilized.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a diagram illustrating a command button showing focus.

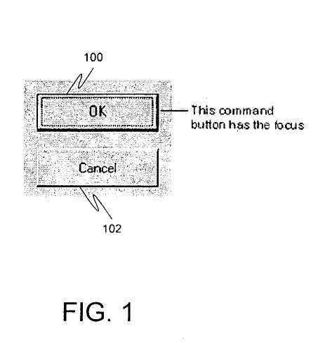

FIG. 2 is a diagram illustrating an example of a text input screen in accordance with an embodiment of the present invention.

FIG. 3 is a diagram illustrating an example of a text input screen wherein a change to one control causes an interdependent change in another in accordance with an embodiment of the present invention.

FIG. 4 is a diagram illustrating an example of a text input screen where a cursor-down event was entered in accordance with an embodiment of the present invention.

FIG. 5 is a flow diagram illustrating a method for handling an input from a user, the input having a type, in accordance with an embodiment of the present invention.

FIG. 6 is a flow diagram illustrating a method for handling an input from a user in accordance with another embodiment of the present invention.

FIG. 7 is a block diagram illustrating an apparatus for handling an input from a user, the input having a type, in accordance with an embodiment of the present invention.

FIG. 8 is a block diagram illustrating an apparatus for handling an input from a user in accordance with another embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention provides multiple foci so that a user may enter input into multiple objects without having to switch between them. This may be accomplished by mapping certain types of input events to specific objects within the graphical user interface. Thus, when inputs of a certain type are received, one focus is utilized, wherein when inputs of another type are received, a different focus may be utilized.

An example will be provided herein that distinguishes between text based and navigation events. One of ordinary skill in the art will recognize that this is merely an example and should not be read to limit the scope of the claims to text-based and navigation events. Additionally, the present invention may be utilized to provide simultaneous access to any number of foci. While two foci are used in the example, three or more foci may also be utilized by alternative embodiments.

For purposes of this disclosure, an input focus may be defined as the location where the user is currently directing input. Additionally, a cursor may be defined as the visible indication of where a user's interaction will occur.

In an embodiment of the present invention, text entry events (i.e., “printable” Unicode symbols such as “A-Z” or “0-9”) and editing events (e.g., backspace, delete, etc.) may be processed by a “text entry box” control, irrespective of navigation events. Navigational events (e.g., “up”, “down”, and possible “left” and “right” arrows) and action events (e.g., “carriage return”, “action-button”, “soft-key1 button”, “soft-key2 button”) are processed by a menu-browser, irrespective of text-entry events. Of course, these navigation buttons will vary depending on the hardware available to the device.

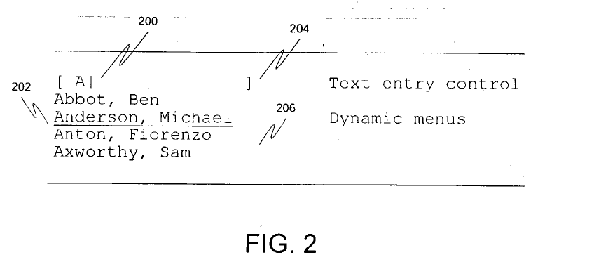

FIG. 2 is a diagram illustrating an example of a text input screen in accordance with an embodiment of the present invention. There are two “cursors” shown. The cursor for text-extry is shown with a vertical bar “|” 200 while the cursor for the menu 202 is shown with an underline. This is distinctly different from standard graphical user interfaces, which do not have two cursors at the same time. At this point, the user may type another letter, which will be fed to the text-entry field (“text entry box” control) 204, or a navigation (up/down) event that will be fed to the menu (“list control”) 206 according to the mapping provided. Here, a text input can aid in a search for a name in a directory, and a navigation request can scroll through the names.

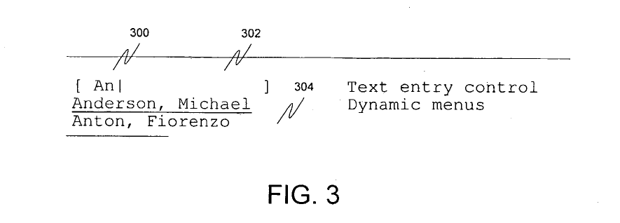

In one embodiment of the present invention, even though the event is sent to one control or the other, a change in one control may cause an interdependent change to the other a secondary result. FIG. 3 is a diagram illustrating an example of a text input screen wherein a change to one control causes an interdependent change in another in accordance with an embodiment of the present invention. Here, an “n” 300 has been input, which is added to the text-entry field 302 of the text entry box control. In this embodiment, only the list of contacts that match the filter entered in the text-entry window are displayed, thus two entries are deleted from the dynamic menus 304. However, the cursor within these menus remains unchanged.

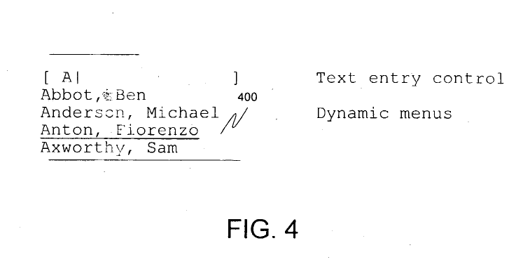

FIG. 4 is a diagram illustrating an example of a text input screen where a cursor-down event was entered in accordance with an embodiment of the present invention. Here, the user navigated down one entry. The cursor 400, therefore, moved down one entry. The user may, therefore, move either control independently without having to shift focus from one control to the other. This has the capability to drastically reduce the navigation requirements on the user.

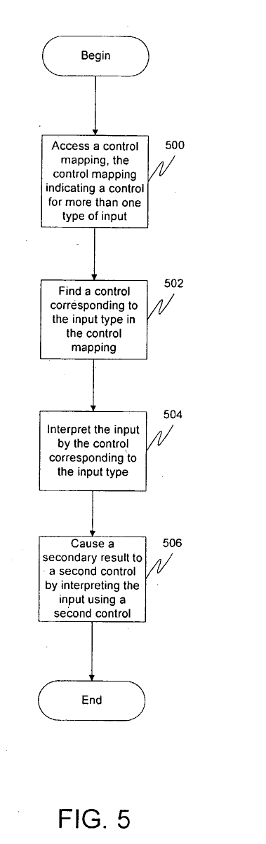

FIG. 5 is a flow diagram illustrating a method for handling an input from a user, the input having a type, in accordance with an embodiment of the present invention. At 500, a control mapping is accessed the control mapping indicating a control for more than one type of input. At 502, a control corresponding to the input type is found in the control mapping. At 504, the input is interpreted by (which may also be called “routed to”) the control corresponding to the input type. At 506, a secondary result may be caused to a second control by interpreting the input using the second control. For example, the names in a list may be modified by adding a character to a text control even though the list control associated with the list is not the control to which the input is originally routed.

The control mapping need not be a separate data structure. It can be hardwired into the application itself. Any number of foci may be used as long as any given input is unambiguously interpreted by a specific focus.

In a more specific embodiment, the mapping for a Smartphone may be as follows:

| Input Event | Routing |
|---|---|
| Printable Unicode Symbol | Text-entry Control |
| Delete/Backspace/Back Key | Text-entry Control |
| Directional Pad (left/right/up/down arrows) | List Control |
| Soft Keys (left and right buttons under the | List Control |
| display) | |
| Send Key | List Control |
| End Key | Text-entry Control |

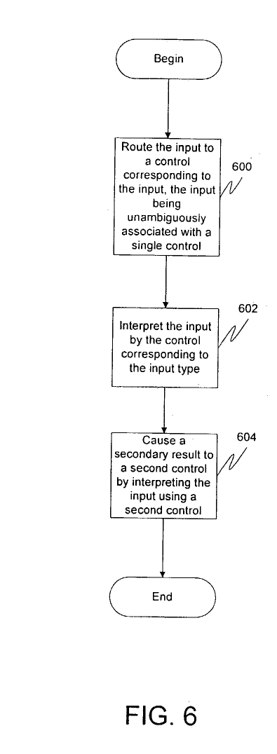

FIG. 6 is a m illustrating a method for handling an input from a user in accordance with another embodiment of the present invention. At 600, the input is routed to a control corresponding to the input, the input being unambiguously associated with a single control. At 602, the input is then interpreted using the control corresponding to the input. At 604, a secondary result may be caused to a second control by interpreting the input using the second control. For example, the names in a list may be modified by adding a character to a text control even though the list control associated with the list is not the control to which the input is originally routed.

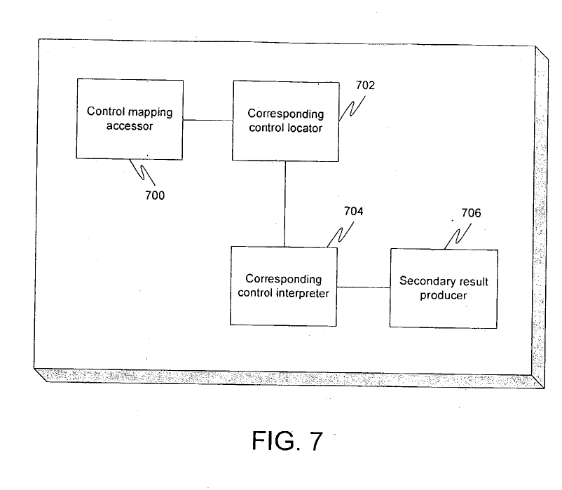

FIG. 7 is a block diagram illustrating an apparatus for handling an input from a user, the input having a type, in accordance with an embodiment of the present invention. A control mapping accessor 700 may access a control mapping, the control mapping indicating a control for more than one type of input. A corresponding control locator 702 coupled to the control mapping accessor 700 may find a control corresponding to the input type in the control mapping. A corresponding control input interpreter 704 coupled to the corresponding control locator 702 may interpret the input using the control corresponding to the input type. A secondary result producer 706 coupled to the corresponding control input interpreter 704 may cause a secondary result to a second control by interpreting the input using the second control. For example, the names in a list may be modified by adding a character to a text control even though the list control associated with the list is not the control to which the input is originally routed.

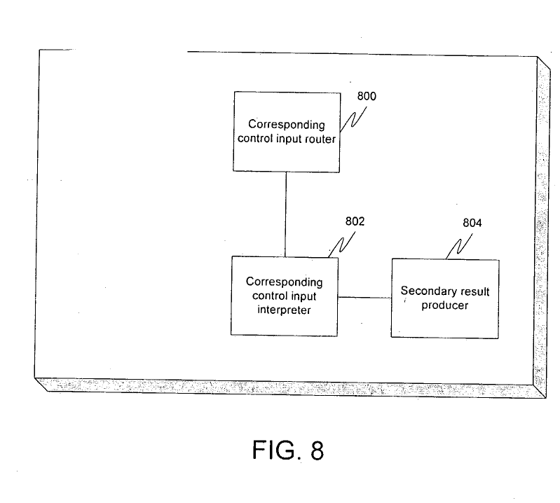

FIG. 8 is a block diagram illustrating an apparatus for handling an input from a user in accordance with another embodiment of the present invention. A corresponding control input router 800 may route the input to a control corresponding to the input, the input being unambiguously associated with a single control. A corresponding control input interpreter 802 coupled to the corresponding control input router 800 may interpret the input using the control corresponding to the input. A secondary result producer 804 coupled to the corresponding control input interpreter 802 may cause a secondary result to a second control by interpreting the input using the second control. For example, the names in a list may be modified by adding a character to a text control even though the list control associated with the list is not the control to which the input is originally routed.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for handling an input from a user, the input having a type, the method comprising:
accessing a control mapping, the control mapping indicating a control for each of more than one types of input;
locating a control corresponding to the input type in the control mapping; and
interpreting the input using the control corresponding to the input type.

2. The method of claim 1, further comprising:
causing a secondary result to a second control by interpreting said input using said second control.

3. The method of claim 1, wherein said input type is a text-entry event and said control is a text-entry box control.

4. The method of claim 1, wherein said input type is a navigation event and said control is a list control.

5. The method of claim 1, wherein said mapping indicates that a printable unicode symbol input corresponds to a text-entry control.

6. The method of claim 5, wherein said mapping further indicates that a delete/backspace/back key input corresponds to a text-entry control.

7. The method of claim 6, wherein said mapping further indicates that a directional pad input corresponds to a list control.

8. The method of claim 7, wherein said mapping further indicates that a soft key input corresponds to a list control.

9. The method of claim 8, wherein said mapping further indicates that a send key input corresponds to a list control.

10. The method of claim 9, wherein said mapping further indicates that an end key input corresponds to a text-key control.

11. The method of claim 1, wherein said control for each of said more than one types of input is unique to said type of input.

12. The method of claim 1, wherein each of said controls in the control mapping has an active cursor.

13. A method for handling an input from a user, the method comprising:
routing said input to a control corresponding to the input, said input being unambiguously associated with a single control; and
interpreting the input using the control corresponding to the input.

14. The method of claim 13, further comprising:
causing a secondary result to a second control by interpreting said input using said second control.

15. The method of claim 13, wherein any text-entry events are unambiguously associated with a text-entry box control.

16. The method of claim 13, wherein any navigation events are unambiguously associated with a list control.

17. The method of claim 13, wherein any printable unicode symbol inputs are unambiguously associated with a text-entry control.

18. The method of claim 17, wherein a delete/backspace/back key input is unambiguously associated with a text-entry control.

19. The method of claim 18, wherein any directional pad inputs are unambiguously associated with a list control.

20. The method of claim 19, wherein any soft key inputs are unambiguously associated with a list control.

21. The method of claim 20, wherein a send key input is unambiguously associated with a list control.

22. The method of claim 21, wherein an end key input is unambiguously associated with a text-key control.

23. The method of claim 14, where in said first control and said second control each have an active cursor.

24. An apparatus for handling an input from a user, the input having a type, the apparatus comprising:
a control mapping accessor;
a corresponding control locator coupled to said control mapping accessor; and
a corresponding control input interpreter coupled to said corresponding control locator.

25. The apparatus of claim 24, further comprising:
a secondary result producer coupled to said corresponding control input interpreter.

26. An apparatus for handling an input from a user, the apparatus comprising:
a corresponding control input router; and
a corresponding control input interpreter coupled to said corresponding control input router.

27. The apparatus of claim 26, further comprising:
a secondary result producer coupled to said corresponding control input interpreter.

28. An apparatus for handling an input from a user, the input having a type, the apparatus comprising:
means for accessing a control mapping, the control mapping indicating a control for each of more than one types of input;
means for locating a control corresponding to the input type in the control mapping; and
means for interpreting the input using the control corresponding to the input type.

29. The apparatus of claim 28, further comprising:
means for causing a secondary result to a second control by interpreting said input using said second control.

30. The apparatus of claim 28, wherein said input type is a text-entry event and said control is a text-entry box control.

31. The apparatus of claim 28, wherein said input type is a navigation event and said control is a list control.

32. The apparatus of claim 28, wherein said mapping indicates that a printable unicode symbol input corresponds to a text-entry control.

33. The apparatus of claim 32, wherein said mapping further indicates that a delete/backspace/back key input corresponds to a text-entry control.

34. The apparatus of claim 33, wherein said mapping further indicates that a directional pad input corresponds to a list control.

35. The apparatus of claim 34, wherein said mapping further indicates that a soft key input corresponds to a list control.

36. The apparatus of claim 35, wherein said mapping further indicates that a send key input corresponds to a list control.

37. The apparatus of claim 36, wherein said mapping further indicates that an end key input corresponds to a text-key control.

38. The apparatus of claim 28, wherein said control for each of said more than one types of input is unique to said type of input.

39. The apparatus of claim 28, wherein each of said controls in the control mapping has an active cursor.

40. An apparatus for handling an input from a user, the apparatus comprising:
means for routing said input to a control corresponding to the input, said input being unambiguously associated with a single control; and
means for interpreting the input using the control corresponding to the input.

41. The apparatus of claim 40, further comprising:
means for causing a secondary result to a second control by interpreting said input using said second control.

42. The apparatus of claim 40, wherein any text-entry events are unambiguously associated with a text-entry box control.

43. The apparatus of claim 40, wherein any navigation events are unambiguously associated with a list control.

44. The apparatus of claim 40, wherein any printable unicode symbol inputs are unambiguously associated with a text-entry control.

45. The apparatus of claim 40, wherein a delete/backspace/back key input is unambiguously associated with a text-entry control.

46. The apparatus of claim 45, wherein any directional pad inputs are unambiguously associated with a list control.

47. The apparatus of claim 46, wherein any soft key inputs are unambiguously associated with a list control.

48. The apparatus of claim 47, wherein a send key input is unambiguously associated with a list control.

49. The apparatus of claim 48, wherein an end key input is unambiguously associated with a text-key control.

50. The apparatus of claim 40, where in said first control and said second control each have an active cursor.

51. A program storage device readable by a machine, tangibly embodying a program of instructions executable by the machine to perform a method for handling an input from a user, the input having a type, the method comprising:
accessing a control mapping, the control mapping indicating a control for each of more than one types of input;
locating a control corresponding to the input type in the control mapping; and
interpreting the input using the control corresponding to the input type.

52. A program storage device readable by a machine, tangibly embodying a program of instructions executable by the machine to perform a method for handling an input from a user, the method comprising:
routing said input to a control corresponding to the input, said input being unambiguously associated with a single control; and
interpreting the input using the control corresponding to the input.
